(19) United States
(12) Patent Application Publication
(10) Pub. No.: US 2006/0245605 A1
(43) Pub. Date: Nov. 2, 2006

(54) Broadcast receiver, broadcast reception control program, and reception channel switching method

(75) Inventor: Ayako Matsunaga, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/411,922

(22) Filed: Apr. 27, 2006

(30) Foreign Application Priority Data
Apr. 28, 2005 (JP) 2005-131850

(51) Int. Cl. H02B 1/00

(52) U.S. Cl. 381/123

(57) ABSTRACT

The broadcast receiver has a key input unit that inputs user instruction information concerning broadcast reception, such as a channel setting by the user and information concerning selection of a broadcasting station or program; a historical switching information holding unit that accumulates switching information, which includes such information as the position and time when the channel was switched and the channels before and after switching the channel; and a switching condition search unit that searches the historical switching information holding unit to determine whether or not there is user instruction information input through the key input unit or switching information matching the position information and time information for when the user instruction information was input through the key input unit, and if any, extracts the appropriate switching information to generate switching condition information.

### BACKGROUND OF THE INVENTION

1. Field of the Invention

The present invention relates to a broadcast receiver with which radio broadcasts can be received, such as a cell phone, PDA and radio. More particularly, it relates to a broadcast receiver, a broadcast reception control program and a reception channel switching method that allow the user to continue to view the same broadcast program even if the reception condition of the program has deteriorated or if the channel on which the program is broadcast has changed.

2. Description of the Related Art

In the current TV and radio broadcasting services, the channel (frequency) used by a broadcasting station and its affiliated stations may vary from one region to another.

This means that a broadcast program being broadcast by a broadcasting station and its affiliated stations in one time zone may be received on different channels (frequencies) depending on which region the user is located in.

As a result, in a broadcast receiver incorporated in a cell phone or automobile to allow the user to receive broadcasts while traveling, situations may occur wherein the receiver is receiving broadcast waves while traveling, but once it leaves the range of the broadcast wave it becomes unable to receive broadcast waves carrying the same content (the same program) as the broadcast wave that the receiver has been receiving.

In order for the broadcast receiver to continue to receive in the area it has entered broadcast waves carrying the same content as the one transmitted by the broadcast wave that the receiver has been receiving, it is necessary for the broadcast receiver to be switched from the channel transmitting the broadcast wave that the receiver has been receiving to another channel transmitting broadcast waves carrying the same content as the one transmitted by the broadcast waves that the receiver has been receiving.

A conventional method of switching from one channel to another responsive to the movement of a broadcast receiver performs channel switching when the reception condition of the broadcast wave that the broadcast receiver is currently receiving has deteriorated or when the broadcast receiver has entered the adjacent broadcasting area.

Examples of such conventional method of changing from one channel to another responsive to the movement of a broadcast receiver are disclosed in Japanese Patent Laying-Open No. 7-284030 (Literature 1), No. 8-140004 (Literature 2), and 2001-53635 (Literature 3).

The arts disclosed in Literatures 1 to 3 respectively switches to an appropriate channel in the area which a broadcast receiver has entered, by detecting a change in the receiving position or a deterioration in the receiving condition of the broadcast receiver, based on the information on receivable channels in different areas; this information is acquired by searching for receivable channels or through other means and is stored in the broadcast receiver beforehand.

The conventional channel switching method responsive to the movement of a broadcast receiver has a problem that the channel is switched irrespective of which timing the user prefers.

For example, a broadcast receiver presenting images and sounds on a certain channel to the user may experience a disturbance in the reception images and sounds, as the broadcast receiver moves away from the station transmitting the broadcast wave of that channel. If the disturbance is so small that the broadcast content is acceptable and comprehensible to the user, the user may want to wait until a CM (Commercial Message) begins or the program ends, instead of switching the channel immediately. Since the conventional channel switching method switches the channel to another irrespective of the intention of the user, the user may possibly miss an important part of the program while the switching is taking place.

In a digital broadcast using ground waves (ground digital broadcast), it will take one to several seconds after the channel is changed before images are presented. If therefore the broadcast receiver automatically forces the channel to be switched, the user will miss a longer part of the program than in an analog broadcast. The possibility of this kind of user inconveniences will increase because many countries have launched and are planning to launch digital broadcasting using ground waves that can be viewed on a broadcast receiver incorporated in a mobile terminal (e.g., cell phone or PDA), like Japan that started ground wave digital broadcasting recently. Considering the foregoing, if the channel is switched automatically, it is preferably done at a timing that will not adversely affect the viewing experience of the user.

### SUMMARY OF THE INVENTION

An object of the present invention is to provide a broadcast receiver, a broadcast reception control program and a reception channel switching method that can solve the above-described drawbacks of the conventional arts by allowing the reception channel to be changed at a timing that better meets the user's preference if the receiving condition of the broadcast program being presented to the user has deteriorated or if the channel broadcasting the broadcast program has changed.

In order to achieve the object described above, in a broadcast receiver with a radio broadcast reception function, the present invention creates switching conditions for switching the channel, based on the switching information indicating the status of when the user switched the channel in the past, and switches the channel when a switching condition is met.

According to another aspect of the present invention, when the created switching condition is met, receivable channels are presented and the channel is switched in accordance with the created switching condition and the user's channel switching instruction.

According to the present invention, a switching condition for switching the channel is created based on the switching information indicating the times and positions at which the user switched the channel in the past, and the channel is switched when the same time or position as the time or position at which the user switched the channel in the past is reached, that is, when the switching condition is met.

When the switching condition is met, receivable channels are presented, from which the user can select a receivable channel and the timing to switch the channel.

According to the broadcast receiver, the broadcast reception control program and the reception channel switching method of the present invention, the user convenience can be enhanced by allowing the reception channel to be changed at a timing that better meets the user's preference.

The first reason for this is that the present invention creates switching conditions for switching the channel, based on the channel switching information indicating the status of when the user switched the channel in the past, and switches the channel when a switching condition is met.

The second reason is that the present invention creates switching conditions for switching the channel, based on the channel switching information indicating the status of when the user switched the channel in the past, presents the receivable channels when a switching condition is met, and switches the channel in accordance with the created switching condition and the user's channel switching instruction.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the functional configuration of a broadcast receiver according to the first embodiment of the present invention;

FIG. 2 is a block diagram showing a hardware configuration of the broadcast receiver according to the first embodiment of the present invention;

FIG. 3 is a flow chart illustrating the operation of the broadcast receiver according to the first embodiment of the present invention;

FIG. 4 is a flow chart illustrating the operation of the broadcast receiver according to the first embodiment of the present invention;

FIG. 5 is a flow chart illustrating the operation of the broadcast receiver according to the second embodiment of the present invention;

FIG. 6 is a flow chart illustrating the operation of the broadcast receiver according to the third embodiment of the present invention;

FIG. 7 is a flow chart illustrating the operation of concrete example 1 of the broadcast receiver according to the first embodiment of the present invention;

FIG. 8 is an example of historical switching information generated by the historical switching information holding unit 20 according to concrete example 1 of the present invention by accumulating the switching information;

FIG. 9 is an example of switching condition information generated through the process of generating switching condition information by concrete example 1 of the present invention; and

FIG. 10 is an example of historical switching information generated by the historical switching information holding unit 20 according to concrete example 1 of the present invention based on the switching information accumulated therein.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

The embodiments of the present invention will now be described in detail with reference to the drawings.

### First Embodiment

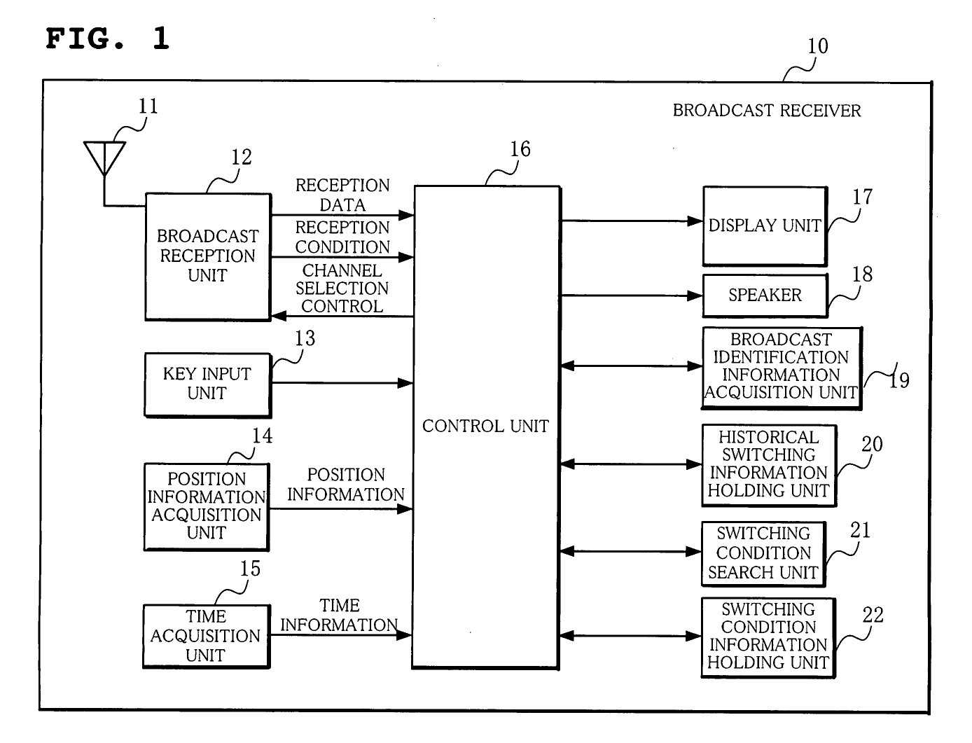

FIG. 1 is a block diagram showing the configuration of a broadcast receiver according to the first embodiment of the present invention.

### DESCRIPTION OF CONFIGURATION

With reference to FIG. 1, a broadcast receiver 10 according to the first embodiment is a computer processor that allows the channel to be changed at the timing meeting the user's preference wherever practicable when the channel broadcasting the current program has changed due to a movement or other reason. The broadcast receiver 10 has an antenna 11, a broadcast reception unit 12, a key input unit 13, a position information acquisition unit 14, a time information acquisition unit 15, a control unit 16, a display unit 17, a broadcast identification information acquisition unit 19, a historical switching information holding unit 20, and a switching condition information holding unit 22.

The antenna 11 has a function to receive signals, and inputs the received signals into the broadcast reception unit 12.

The broadcast reception unit 12 is a circuit to receive TV broadcast programs received by the antenna 11, and has a function to generate data from the signals received from the antenna 11. The broadcast reception unit 12 generates reception data (images, sounds, etc.) by, among the signals input from the antenna 11, selectively decoding the signals of the frequency corresponding to the channel designated by the control unit 16, and inputs this reception data into the control unit 16.

The key input unit 13 includes various operation keys to operate the broadcast receiver 10, keys to enter letters, numbers and other characters, and so on. It has a function to input user instruction information concerning broadcast reception, such as information concerning channel settings and selection of a broadcasting station/program by the user, and transmits the input user instruction information to the control unit 16.

The position information acquisition unit 14 has a function to acquire position information (latitude, longitude, and altitude) for the broadcast receiver 10 through use of, for example, the GPS (Global Positioning System), and transmits the acquired position information to the control unit 16.

The time information acquisition unit 15 has a function to acquire time information through use of the incorporated clock, and transmits the acquired time information to the control unit 16.

The control unit 16 is a circuit to control the process operation of the broadcast receiver 10, and controls activities related to broadcast reception.

More specifically, the control unit 16 has functions to perform all the control processes conducted by the broadcast receiver 10, including signal reception control, decoding of reception data (images, sounds, etc.), and reception data display control. The control unit 16 performs signal reception control, reception data display control and other capabilities, based on the position information transmitted from the position information acquisition unit 14 and the time information transmitted from the time information acquisition unit 15. The control unit 16 then decodes the reception data input from the broadcast reception unit 12 into images, sounds and other information, and outputs the resultant information into the display unit 17.

A hardware configuration of the broadcast receiver 10 according to the first embodiment will now be described.

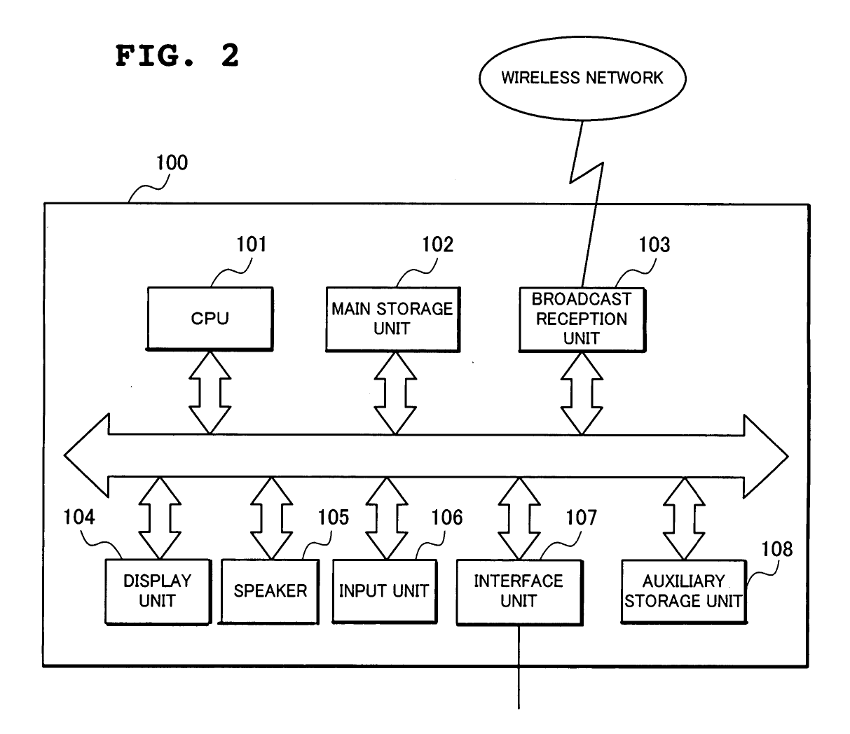

FIG. 2 is a block diagram showing a hardware configuration of the broadcast receiver 10.

With reference to FIG. 2, the broadcast receiver 10 according to this embodiment can be realized by a hardware configuration 100 similar to that of a typical computer processor, and has a CPU 101; a main storage unit 102, such as a RAM or ROM; a broadcast reception unit 103 to receive broadcast waves and input digital data, etc.; a display unit 104, such as an LCD display; a speaker 105; an input unit 106, such as a keyboard and a mouse; an interface unit 107; an auxiliary storage unit, such as a nonvolatile memory, DRAM, or hard-disc device; and so on.

In addition to the ability to be implemented as hardware, the broadcast receiver 10 can also be implemented as software by executing a broadcast reception control program on the CPU 301 (control unit 16) incorporated in the broadcast receiver 10, thereby providing functions involved in receiving broadcasts and processing received data. This broadcast reception control program is stored in the auxiliary storage unit 308, and realizes the above-stated functions by being loaded from the auxiliary storage unit 308 via the main storage unit 302 to the CPU 301, where the operation of this program is controlled.

The display unit 17 is an LCD display or the like, and has functions to display the image and other information transmitted from the control unit 16 to the user. The display unit 17 displays the content of the broadcast program received by the broadcast reception unit 11, displays that a channel switching condition has been met, displays multiple candidate channels to which the user can switch, and displays various other information according to the other functions provided with the broadcast receiver 10.

The speaker 18 is a stereo speaker or the like, and has functions to output the sound and other information transmitted from the control unit 16 to the user. The speaker 18 outputs the content of the broadcast program received by the broadcast reception unit 11, notifies that a channel switching condition has been met by issuing an announcement, providing an electronic sound or other means, and indicates multiple candidate channels to which the user can switch.

The broadcast identification information acquisition unit 19 has functions to acquire broadcast identification information, which indicates the channels, network IDs, names of broadcasting stations or other IDs to identify broadcast waves, and program names before and after switching the channel, the start and end times of the program, and the receiving condition (such as the intensity of the received radio wave), and transmits the acquired broadcast identification information to the control unit 16.

The historical switching information holding unit 20 has a function to accumulate the positions and times at which the channel was switched and the switching information consisting of information on the channels before and after switching the channel, etc., and a function to hold the data as the historical switching information. This historical switching information is stored in a nonvolatile memory, DRAM, memory card or other device.

Information on the channels before and after switching the channel, etc., contains the broadcast identification and other information acquired by the broadcast identification information acquisition unit 19, including: the channels, IDs to identify broadcast waves (such as the network ID and the name of the broadcasting stations) and program names before and after switching the channel; the start and end times of the program; and the receiving condition, such as the intensity of the received radio wave.

The switching condition search unit 21 has functions to (i) search the historical switching information held by the historical switching information holding unit 20, (ii) to determine whether or not the switching information exists that matches: the user instruction information input through the key input unit 13; the position information and time information acquired by the position information acquisition unit 14 and the time information acquisition unit 15, for when the user instruction information was input through the key input unit 13; or the broadcast identification information acquired by the broadcast identification information acquisition unit 19, and (iii) if such information exists, to extract the appropriate switching information and generate switching condition information. The switching condition search unit 21 transmits the generated switching condition information to the switching condition information holding unit 22.

The switching condition search unit 21 also has a function to set the conditions indicated by the generated switching condition information or the condition indicated by the switching condition information acquired from the switching condition information holding unit 22, as the switching condition for the channel switching process controlled by the control unit 16.

Switching condition information indicates conditions for changing the channel of the broadcast being displayed by the display unit 17. This information includes: the time and position to switch the channel; the channel after switching; IDs to identify broadcast waves, such as the network ID and the name of the broadcasting station; the BERs (Bit Error Rates), C/Ns (Carrier to Noise Ratios) and field intensities that triggered channel switching in the past; and so on.

The switching condition information holding unit 22 has a function to hold the switching condition information generated by the switching condition search unit 21.

The switching condition information holding unit 22 also has a function to, if for example the broadcast program displayed by the display unit 17 is the same between before and after switching the channel, integrate and hold the switching condition information generated by the switching condition search unit 21, and, among the switching condition information held by the switching condition information holding unit 22, the switching condition information with the time, position, etc., to switch the channel that are closer to the time, position, etc., indicated by the switching condition information generated by the switching condition search unit 21.

The broadcast receiver 10 according to this embodiment switches the channel of the broadcast being displayed by the display unit 17, if the switching conditions indicated by this switching condition information are met.

While FIG. 1 primarily shows the components of the broadcast receiver 10 that are necessary to implement the functions to receive and display broadcasts, it will be appreciated that the broadcast receiver 10 will have various other components depending on the other functions that the receiver may have.

For example, the broadcast receiver 10 may include components that implement camera functions or telephone/communication functions.

### DESCRIPTION OF OPERATION

The operation of the broadcast receiver 10 according to the first embodiment will now be described.

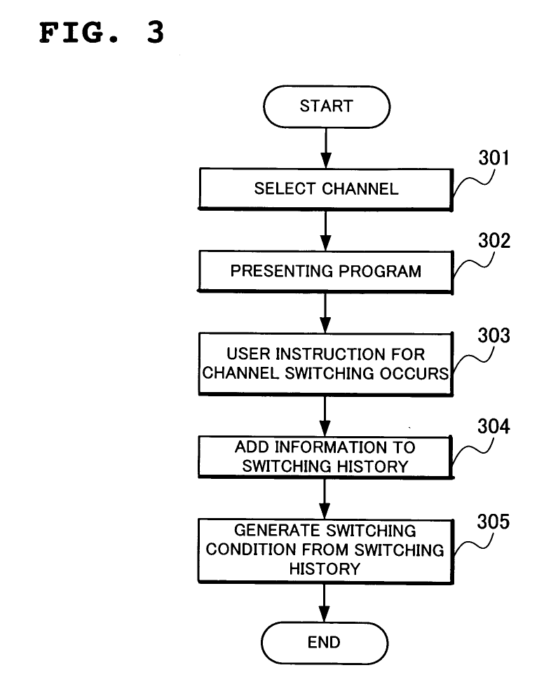

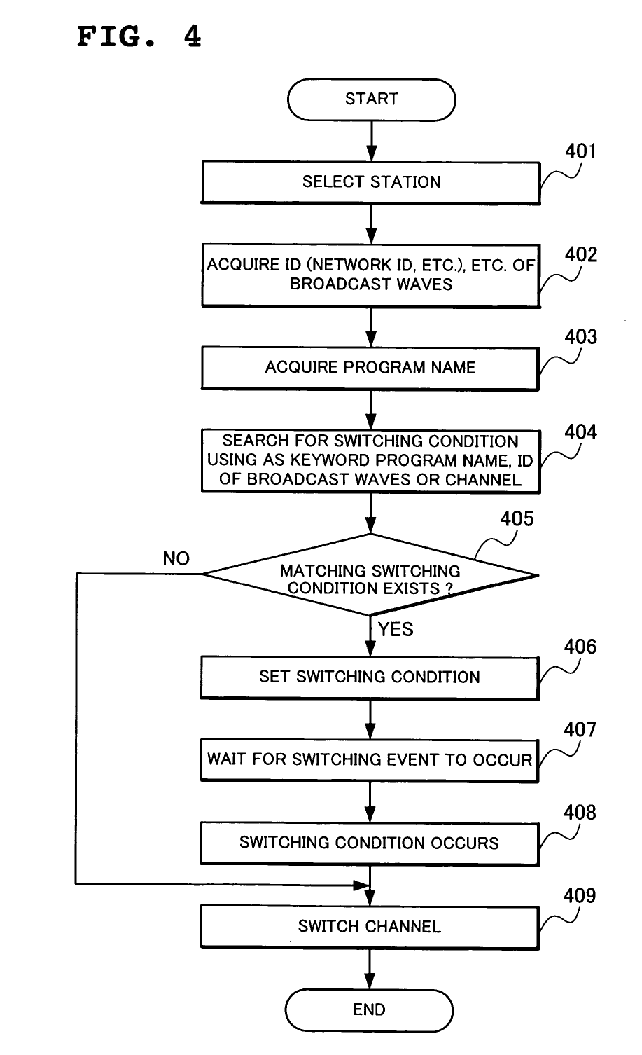

The process of generating channel switching condition information and the process of switching the channel, performed by the broadcast receiver 10 according to this embodiment, will be described with reference to the flow charts in FIGS. 3 and 4.

FIG. 3 is a flow chart illustrating the process of generating channel switching condition information by the broadcast receiver 10 according to this embodiment.

The broadcast receiver 10 first selects the channel designated by the user (step 301) and presents the designated program to the user through the display unit 17 and the speaker 18.

While the designated program is being presented (step 302), the key input unit 13 inputs the information of a channel switching instruction, or the user instruction information (step 303).

The position information acquisition unit 14, the time information acquisition unit 15, and the broadcast identification information acquisition unit 19 then acquire the channel switching information, which consists of the time and position at which the key input unit 13 input the information in step 303, the channels and names of the program before and after switching, and so on. The historical switching information holding unit 20 holds this switching information as the historical switching information (step 304). The display unit 17 and the speaker 18 present the user-designated program received after switching the channel, according to the user instruction information.

Next, the switching condition search unit 21 searches the switching information acquired by the position information acquisition unit 14, the time information acquisition unit 15, and the broadcast identification information acquisition unit 19 in step 304, the historical switching information held by the historical switching information holding unit 20, and the switching condition information held by the switching condition information holding unit 22, to retrieve the switching information containing the same program name and the time, position and so on that are close to each other. The switching condition information holding unit 22 integrate the switching information retrieved by the switching condition search unit 21, thereby updating the current switching condition information to generate new switching condition information (step 305).

The broadcast receiver 10 creates switching condition information as described above and uses this switching condition information as the switching condition for switching the channel during the channel switching process described below.

After the below-described channel switching process is performed and the new channel is selected (step 301) and while the program is being presented (step 302), the process of generating channel switching condition information shown in FIG. 3 repeats the above-described steps when the channel switching instruction is given by the user (step 303), thereby updating the current switching condition information and generating new switching condition information (step 305).

FIG. 4 is a flow chart illustrating the channel switching process by the broadcast receiver 10 according to this embodiment.

The key input unit 13 inputs user instruction information, and the control unit 16 selects the channel based on this user instruction information (step 401). When the broadcast reception unit 12 acquires the reception data, the position information acquisition unit 14 and the time information acquisition unit 15 acquire the position information and the time information, respectively, for when the user instruction information was input through the key input unit 13; and the broadcast identification information acquisition unit 19 acquires IDs to identify the broadcast wave, such as the network ID and the name of the broadcasting station, from the broadcast wave on the selected channel (step 402).

At the same time, the broadcast identification information acquisition unit 19 acquires the name of the program that has been selected according to the user instruction information and that is being presented through the display unit 17 and the speaker 18 (step 403).

Using as a keyword the ID, program name and channel of the broadcast wave acquired by the broadcast identification information acquisition unit 19, the switching condition search unit 21 searches the switching information held by the historical switching information holding unit 20 and the switching condition information held by the switching condition information holding unit 22 for the information containing the same program name (step 404) in order to determine whether the applicable switching condition information exists or not (step 405).

In step 404, the switching condition search unit 21 searches the switching information held by the historical switching information holding unit 20.

In step 405, if it determines that the applicable switching information exists in the historical switching information held by the historical switching information holding unit 20, the switching condition search unit 21 transmits the switching information to the switching condition information holding unit 22.

In step 405, if it determines that more than one piece of applicable switching information exists, the switching condition search unit 21 transmits all the applicable switching information to the switching condition information holding unit 22.

Alternatively, if it determines that more than one piece of applicable switching information exists in step 405, the switching condition search unit 21 may transmit the switching information containing the position and time that are the closest to those in the information acquired by the position information acquisition unit 14 and the time information acquisition unit 15 in step 402 to the switching condition information holding unit 22.

If the switching condition information holding unit 22 determines, based on the switching information sent from the historical switching information holding unit 20, that the switching condition information containing the position and time that are close to the newly sent switching information is already held by the switching condition information holding unit 22, then the switching condition information holding unit 22 integrates the newly-sent switching information with the already-held switching condition information and holds the resultant information.

Next, in step 404, the switching condition search unit 21 searches the switching condition information held by the switching condition information holding unit 22.

In step 405, if it determines that the applicable switching condition information exists in the switching condition information held by the switching condition information holding unit 22, the switching condition search unit 21 sets the condition indicated by that switching condition information as the switching condition for the channel switching process controlled by the control unit 16 (step 406).

In step 405, if it determines that more than one piece of applicable switching condition information exists, the switching condition search unit 21 sets the condition indicated by the switching condition information that has been set the most frequently as the switching condition.

Alternatively, the switching condition search unit 21 may set the condition indicated by the switching condition information containing the position and time that are the closest to the position and time in the information acquired by the position information acquisition unit 14 and the time information acquisition unit 15 in step 402.

On the other hand, if in step 404 it fails to find any information containing the same program name through a search of the switching information held by the historical switching information holding unit 20 and the switching condition information held by the switching condition information holding unit 22, then the switching condition search unit 21 determines that there is no applicable switching information because the channel switching process has never been performed on this program name (step 405) and proceeds to step 409, wherein the broadcast receiver 10 performs the channel switching process, using as a trigger an attenuation in the received radio wave, a channel switching instruction from the user or other event.

The broadcast receiver 10 presents as usual the program selected according to the user instruction information through the display unit 17 and the speaker 18. While doing so, the broadcast receiver 10 monitors the position information and time information provided by the position information acquisition unit 14 and the time information acquisition unit 15 in order to detect any status that matches the switching condition set in step 406 (step 407).

If a matching status occurs (step 408), the broadcast receiver 10 switches the channel to the destination channel, which is contained in the switching condition and which has been set in step 406 (step 409).

After switching the channel in step 409, the channel switching process shown in FIG. 4 acquires the position, time and other information (step 402) according to the received data concerning the selected channel (step 401), and repeats the steps above to switch the channel to the destination channel contained in the switching condition (step 409).

As described in the foregoing, the broadcast receiver 10 performs subsequent channel switching processes by utilizing the switching conditions under which the user performed channel switching in the past.

### Second Embodiment

The second embodiment of the present invention will now be described with reference to the drawings.

The configuration of a broadcast receiver according to the second embodiment will not be described herein because it is the same as that of the broadcast receiver according to the first embodiment.

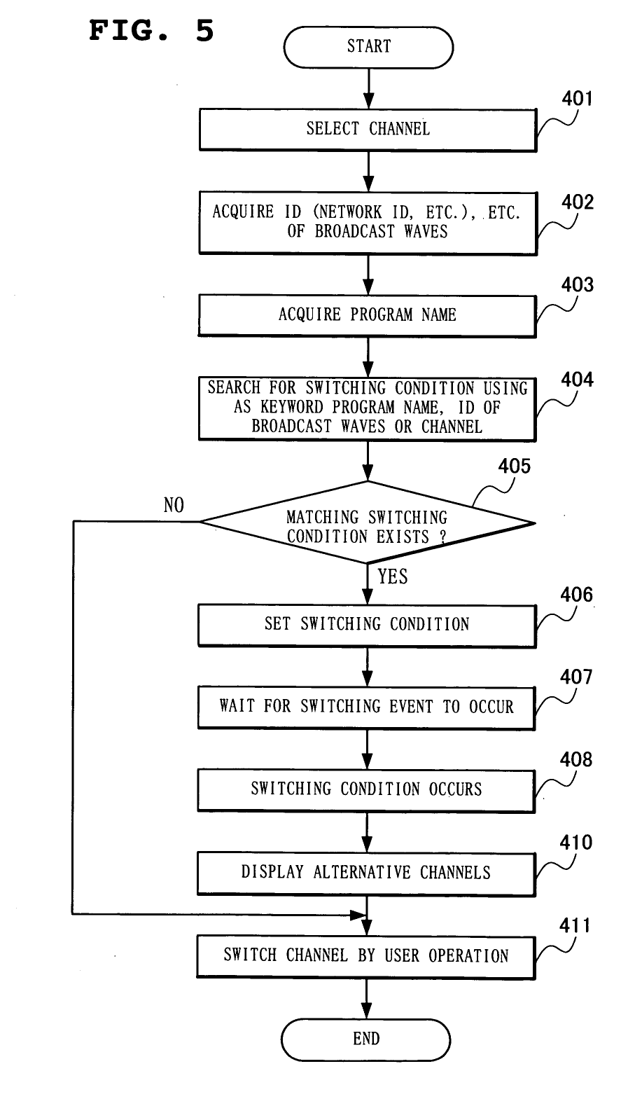

The operation of the broadcast receiver according to the second embodiment will be described with reference to the flow chart in FIG. 5.

FIG. 5 is a flow chart illustrating the channel switching process by the broadcast receiver according to the second embodiment.

The process of generating channel switching condition information by the broadcast receiver of the second embodiment is the same as the first embodiment shown in FIG. 3, except for the channel switching process using switching conditions, which is different from the example of the first embodiment shown in FIG. 4.

When a status matching the switching condition occurs (step 408), the channel switching process by the broadcast receiver of this embodiment does not switches the channel automatically according to the switching condition information generated by the switching condition information holding unit 22. Instead, it presents to the user through the display unit 17 that there is an alternative channel to which the channel was switched in the past at the position and time indicated by the switching condition information (step 410). It then prompts the user to instruct switching to the alternative channel, inputs the channel switching instruction from the user through the key input unit 13, and switches the channel accordingly (step 411).

In the channel switching process by the broadcast receiver of this embodiment, it is possible to select between two modes: one mode prompts the user to instruct switching to an alternative channel, according to the condition indicated by the switching condition information generated by the switching condition information holding unit 22 or according to the user instruction information containing the pre-input mode selection information; and the other mode switches the channel automatically.

Furthermore, in the process of generating channel switching condition information, it is also possible to generate switching condition information using the receivable channel information pre-defined for each broadcasting area (step 305 in FIG. 3), and, when a status matching the switching condition occurs (step 408), to present the receivable channel information for each broadcasting area to the user through the display unit 17 (step 410).

### Third Embodiment

The third embodiment of the present invention will be described below.

The configuration of a broadcast receiver according to the third embodiment will not be described herein because it is the same as that of the broadcast receiver according to the first embodiment.

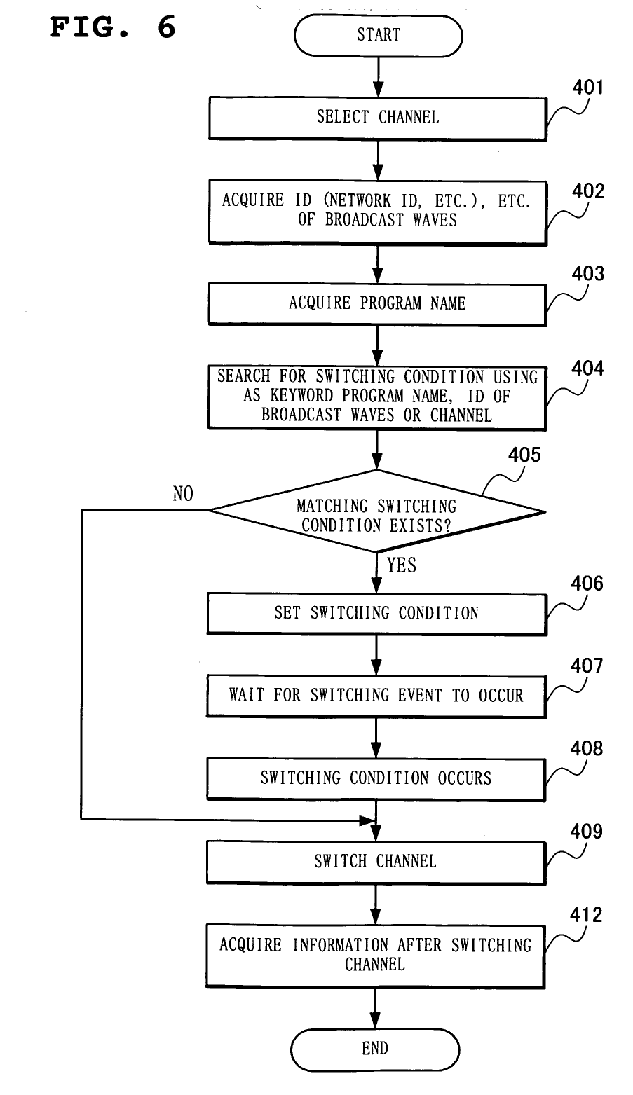

The operation of the broadcast receiver according to this embodiment will be described with reference to the flow chart in FIG. 6.

FIG. 6 is a flow chart illustrating the channel switching process by the broadcast receiver according to this embodiment.

The broadcast receiver of this embodiment differs from the first embodiment shown in FIG. 4 in that a new process is added to the end of the channel switching process.

In the operation of the broadcast receiver according to this embodiment, the channel switching process (step 409) according to the first embodiment is followed by a new process of acquiring information indicating whether or not the switching condition used as the condition for switching the channel is a switching condition instructed by the user (step 412).

More specifically, in this additional process, the historical switching information holding unit 20 according to this embodiment acquires the switching condition information used as the condition for switching the channel in step 409 and the information indicating whether or not this switching condition is a switching condition instructed by the user, and hold them in association with each other (step 412).

In the following examples, the channel switching process (step 409) is not appropriate and thus is assumed not to have been caused by a user instruction. One example is that the broadcast receiver according to this embodiment switches the channel automatically, but user instruction information is input immediately, within several seconds, to return the channel to the previous channel. The second example is that the receiving condition of the channel after switching is lower than a predetermined level.

In these cases, upon channel switching by the broadcast receiver (step 409), the historical switching information holding unit 20 acquires the switching condition information for this channel switching and the inappropriate switching information indicating that this channel switching is not appropriate, and holds the switching condition information and the inappropriate switching information in association with each other (step 412).

Thereafter, when the switching condition search unit 21 according to this embodiment determines whether or not the information meeting the switching information exists in the switching information held by the historical switching information holding unit 20 (step 405), the retrieved switching information associated with the inappropriate switching information is handled as if it did not exist.

### CONCRETE EXAMPLE 1

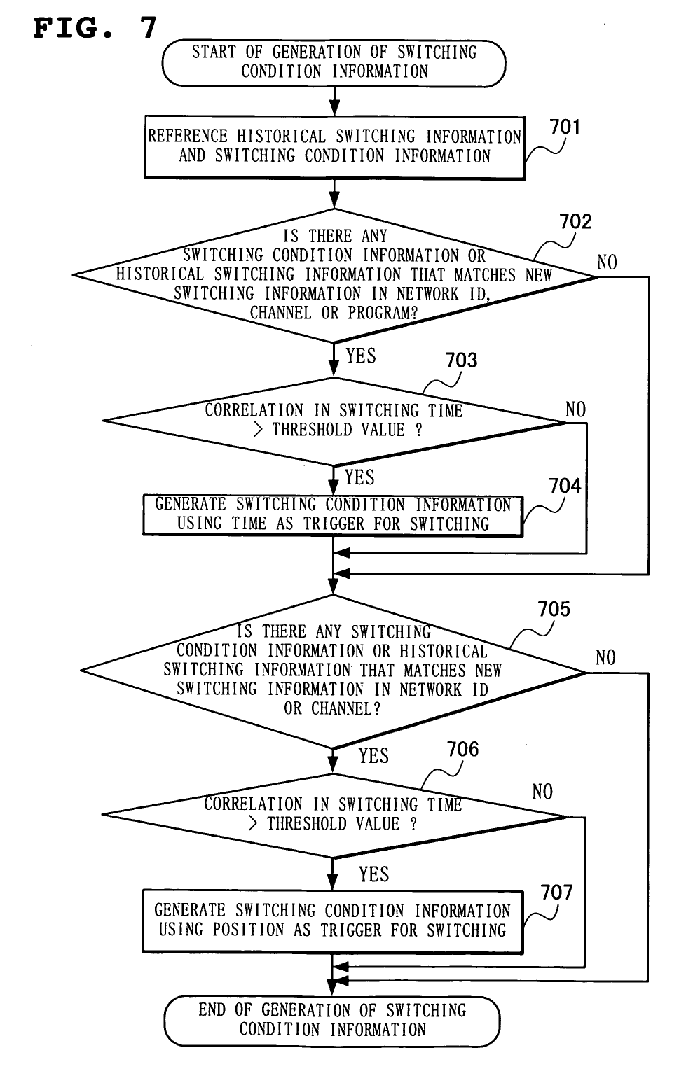

Concrete example 1 of the broadcast receiver 10 according to the first embodiment in FIGS. 1 to 3, when it is applied to ground digital broadcasting, will be described below with reference to FIGS. 7 to 9.

FIG. 7 is a flow chart illustrating the process of generating switching condition information by concrete example 1 of the present invention.

In order to facilitate the understanding of the description of the process of generating switching condition information by concrete example 1 of the present invention, the following paragraphs describe what steps are taken before a same program search takes place and how the historical switching information holding unit 20 accumulates switching information to generate historical switching information.

First, the steps taken before a same program search takes place will be described. A same program search is a function of searching for another channel on which the program that the user has been viewing can be received.

The key input unit 13 inputs the user instruction information, which includes information indicating the channel that the user wants to view. This is done by the user by either selecting a channel from the information presented to the user on the display unit 17 and the speaker 18, such as the EPG (Electronic Program Guide) information or a list of receivable channels as- destinations, or directly designating the channel number to which the user wants the channel to be switched.

The broadcast receiver 10 selects the channel chosen by the user according to the user instruction information input by the key input unit 13 and receives the broadcast waves of the channel after switching.

If, for example, the receiving condition of the broadcast waves received on the channel after switching has deteriorated to make the program incomprehensible to the user, the broadcast receiver 10 initiates the channel switching process by inputting the user instruction information, such as a same program search by the user, through the key input unit 13.

If a same program search finds a channel on which the same program can be received, the historical switching information holding unit 20 holds that information as the switching information.

The following paragraphs will describe how the historical switching information holding unit 20 accumulates switching information to generate the historical switching information.

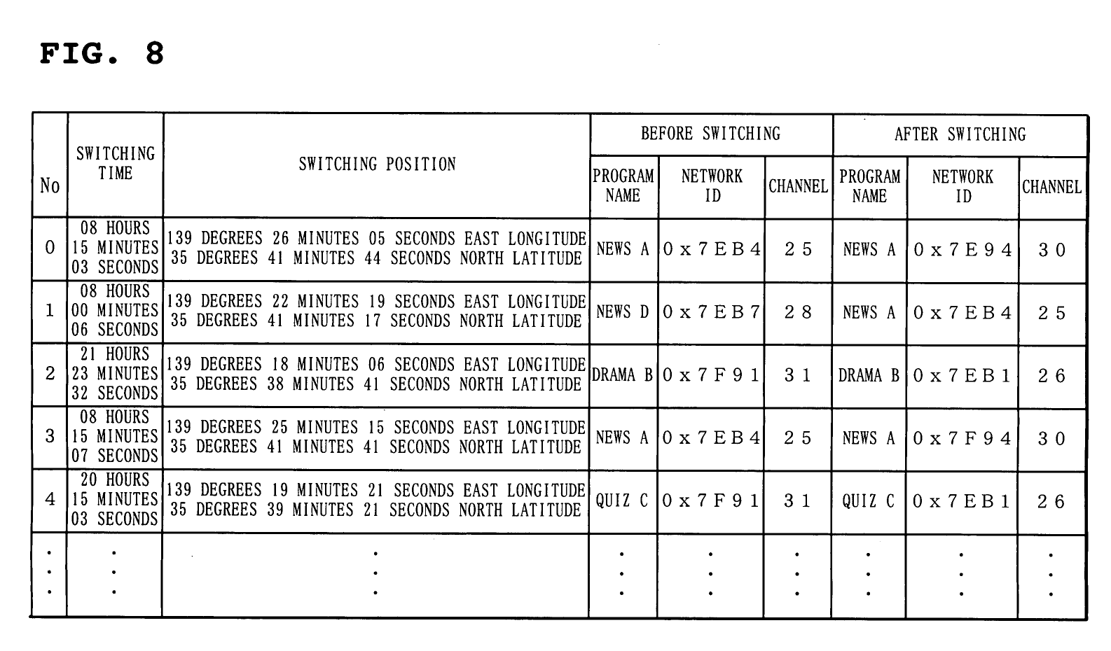

FIG. 8 is an example of historical information generated by the historical switching information holding unit 20 according to concrete example 1 of the present invention by accumulating the switching information.

With reference to FIG. 8, the historical switching information holding unit 20 holds as the component items forming the switching information the time and position at which channel switching took place, and the program names, network IDs and channels before and after switching, and generates the historical switching information therefrom.

For example, suppose that a same program search is invoked by the user while the program name “News A” is being received by the broadcast receiver 10 with network ID 0x7EB4 and on channel 25.

The same program search succeeds in retrieving another channel (network ID=0x7F94, channel=30) on which the user can view “News A,” the same program name as the one the user has been receiving before the same program search. The switching information, representing the information after the currently received channel is switched to the retrieved channel, is held in the component items in the row No. 0.

The process of generating switching condition information according to this concrete example 1 generates switching condition information based on this switching information.

Next, an example of the process of generating switching condition information according to this concrete example 1 will be described.

The switching condition search unit 21 first searches the historical switching information held by the historical switching information 19 (step 701) to retrieve the switching information that matches the switching information newly acquired by the historical switching information 19 in items: program names, network IDs, and channels before and after switching the channel (step 702).

If the search in step 702 reveals that the switching information that matches in these items exists, the switching condition search unit 21 further examines to determine whether or not the time indicated by the retrieved switching information and the time indicated by the newly acquired switching information are correlated with each other (step 703).

If, as a result of examining the correlation in step 703, there exists a combination of switching information whose time correlation equals to or exceeds a predetermined threshold value, the switching condition search unit 21 generates switching condition information that uses the time indicated by the combined switching information as a trigger for switching the channel (step 704).

Furthermore, the switching condition search unit 21 searches the historical switching information held by the historical switching information 19 to retrieve the switching information that matches the switching information newly acquired by the historical switching information 19 in items: network IDs and channels before after switching the channel (step 705).

If the search in step 705 reveals that the switching information that matches in these items exists, the switching condition search unit 21 examines to determine whether or not the position indicated by the retrieved switching information and the position indicated by the newly acquired switching information are correlated with each other (step 706).

If, as a result of examining the correlation in step 306, there exists a combination of switching information whose position correlation equals to or exceeds a predetermined threshold value, the switching condition search unit 21 generates switching condition information that uses the position indicated by the combined switching information as a trigger for switching the channel (step 707).

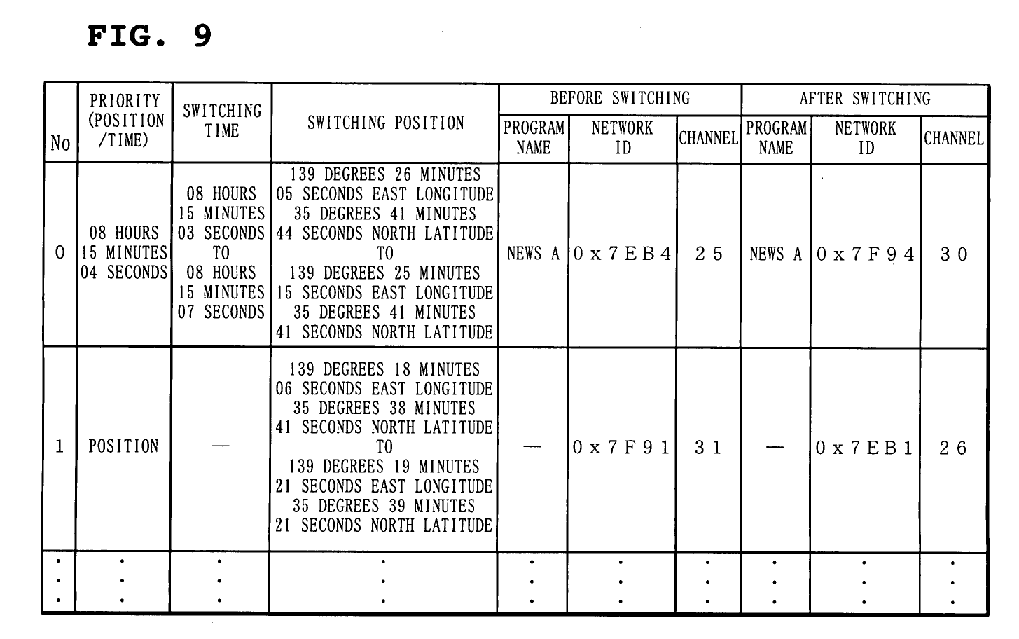

FIG. 9 shows an example of switching condition information generated by the procedure described above.

With reference to FIG. 9, the switching condition information 21 holds switching condition information consisting of the component items: the component item given priority as a switching condition (position or time), the recommended time for switching the channel, the period of time during which the channel can be switched (switching time), the position to switch the channel, and the channels, network IDs and program names before and after switching.

In the case of switching condition information generated by combining multiple pieces of switching information that are highly correlated in time, the recommended switching time for switching the information channel is calculated as a time the most appropriate to be a switching time, based on the channel switching frequency and the receiving condition before and after switching the channel.

For example, referring to the historical switching information in FIG. 8, the No. 0 switching information matches No. 3 in program names, network IDs and channels before and after switching. Therefore, switching condition information is generated based on the information indicated by each component item of these two pieces of switching information. The information indicated by the component items in these two pieces of switching information is considered to have a high degree of correlation in terms of position and time. Switching condition information that appears like No. 0 in FIG. 9 is generated from these pieces of switching information.

Therefore, in the case where the information channel is switched based on the switching condition information as shown in No. 0 in FIG. 9, the recommended switching time for switching the information channel is calculated as a time the most appropriate to be a switching time, based on the channel switching frequency and the receiving condition before and after switching the channel (time: 08 hours 15 minutes 04 seconds).

On the other hand, switching condition information generated from multiple pieces of switching information whose time correlation is low does not hold switching time and program name as its component items.

For example, referring to the historical switching information in FIG. 8, it is noted that the No. 2 switching information and the No. 4 switching information do not match in program name but do match in network IDs and channels before and after switching. This means that these pieces of switching information have a high correlation in position but their correlation in time is not high. For this reason, the switching condition information generated from No. 2 and No. 4 switching information, as shown in No. 1 in FIG. 9, does not have a switching time as a switching condition and thus switching condition information that does not depend on time is generated.

When two pieces of switching information do not match in program name but do match in network IDs and channels before and after switching, this situation reflects that different programs are broadcast in different time zones; that is, the program names may not match even though the network ID and channel of the broadcast waves being received are the same. These pieces of switching information are considered to have a low correlation in time but a high correlation in position.

In one example of switching condition information in FIG. 9, the switching position represents a range where switching took place in the past. In this example, the switching position is indicated as a range determined by two points, because this switching condition information was generated from two pieces of switching information. However, it is also acceptable to indicate a range established with more than two points, by generating switching condition information from multiple number of pieces of highly correlated switching information.

This concrete example 1 performs channel switching using switching condition information generated through the process of generating switching condition information as described above.

For example, if the broadcast receiver 10 according to this concrete example 1 is receiving a program with a program name of “News A” at network ID 0x7EB4 and on channel 25, it waits for the No. 0 switching condition shown in FIG. 9 to occur.

When the position at which the broadcast receiver receives the broadcast waves enters the range indicated by the “range of switching positions” and the time indicated in the recommended “switching time” is reached, the broadcast receiver 10 switches to network ID 0x7F94 and channel 30, with the program name remaining to be “News A,” according to the No. 0 switching condition information shown in FIG. 9.

The switching information may have different program names between before and after channel switching, as is the case with the No. 1 switching information shown in FIG. 8.

The historical switching information 19 holds this type of switching information, in which the program name differs between before and after channel switching. By this, this type of switching information can be used as switching condition information, not only when the user wants to switch the channel to view the same program as the broadcast receiver 10 moves to a different position for receiving broadcast waves, but also when the timing is an interval between two programs and the user wants to switch to an alternative channel of the same or other network.

According to this concrete example 1, by using, for example, time and position information as switching conditions, the broadcast receiver can switch the channel at the time and position where the user is the most likely to switch the channel, based on the historical record of switching activities by the user within a predetermined range of times and positions, if any. Therefore, as the receiving position moves, the broadcast receiver can switch the channel at the timing close to that desired by the user, thereby allowing the user to receive the program viewed by the user frequently at this uniticular time and position.

Furthermore, according to this concrete example 1, by using, for example, position information concerning at which positions the user switched the channel in the past, the broadcast receiver can switch the channel according to the fine segmentation of positions desirable to the user as the reception position of the broadcast receiver moves in a position frequented by the user, thus overriding the receivable channels pre-defined for each area. The broadcast receiver, therefore, can change the way it switches the channel flexibly if the receiving condition of broadcast waves in this area is locally worse than in another area because, for example, the user is in the shadow of a tall building.

### CONCRETE EXAMPLE 2

Concrete example 2 is an example associated with the first embodiment, and differs from concrete example 1 in the switching information held by the historical switching information holding unit 20 as historical switching information. In concrete example 2, in addition to the items of the switching information shown in FIG. 8 in relation to concrete example 1, the historical switching information holding unit 20 holds an item of information indicating the receiving condition of broadcast waves of the broadcast receiver before and after channel switching.

In this concrete example 2, the historical switching information holding unit 20 holds, as switching information, the information indicating the receiving condition of broadcast waves, such as BER (Bit Error Rate), C/N (Carrier to Noise Ratio), and field intensity. The switching condition search unit 21 generates switching condition information from the history of switching information held in the historical switching information holding unit 20 and uses the generated switching condition information for channel switching.

An example of using the switching condition information generated based on information indicating the receiving condition of broadcast waves for switching channels is that, when the receiving condition of broadcast waves before and after channel switching becomes above or below a specific threshold value, this concrete example 2 switches the channel, overriding the switching time or switching position indicated in the switching condition information.

An example of switching the channel by overriding the switching position specified in the switching condition information is that this concrete example 2 switches the channel before reaching the switching position indicated in the switching condition information when the receiving condition of broadcast waves before channel switching becomes below a specific threshold value.

In this case, this concrete example 2 can shift the channel switching position from the position indicated in the switching condition information so that the broadcast receiver can avoid trouble, such as a disruption of the reception of broadcast waves, before reaching the switching position. By this, the program can be presented to the user continuously while maintaining the receiving condition at a level equal to or higher than a predetermined level.

This concrete example 2 can display alternative channels and the receiving condition of broadcast waves on the display unit 17. In this case, it is possible to enter user instruction information into the key input unit 13 to cause the channel to be switched before the switching position or the switching time indicated by the switching condition information is reached if the receiving condition of broadcast waves is lower than a specific threshold value.

Conversely, if the receiving condition of broadcast waves is higher than a specific threshold value, the channel may be switched after the switching position or switching time indicated by the switching condition information is reached.

This means that channel switching events can be shifted from the switching position or switching time indicated in switching information. This is uniticularly useful in ground digital broadcasting, where it takes one to several seconds after the channel is changed before the images are presented. This concrete example 2 can optimize the switching position or switching time by ensuring the channel to be changed under conditions better meeting the preference of the user, thereby avoiding the risk of causing the user to miss a unit of the program being viewed because of a channel switching event.

### CONCRETE EXAMPLE 3

Concrete example 3 is a variant of concrete example 1 described above. The broadcast identification information acquisition unit 19 additionally acquires as broadcast identification information the start time and end time of the program from the broadcast waves that the broadcast receiver is receiving, and the historical switching information holding unit 20 holds the broadcast identification information acquired by the broadcast identification information acquisition unit 19 as switching information.

Channel switching is considered to typically take place at a gap between programs or program sections, for example, at the end of a section of a program, during a CM (Commercial Message), or during an interval between two programs; the time of such a gap will change with changes in the start time or the length of a program.

To deal with this problem, this concrete example 3 can determine whether the program schedule is different from usual by also holding the start time and end time of a program as switching information and using it as switching condition information. If the start time and end time of a program are different from usual, this concrete example 3 determines that the program schedule is special and that the time of a program gap at which the channel should be changed is different from usual, and prevents the channel from being switched.

In this concrete example 3, the broadcast receiver's control unit 16 may be designed to have a function to determine whether or not a flag indicating that the program schedule within the broadcast waves is different from usual is on, so that the channel will not be switched automatically if this flag is on.

Furthermore, in this concrete example 3, the broadcast receiver's control unit 16 may be designed to have a function to detect the state of a program (e.g., during a CM), so that the detected information indicating the state of the program can be used as switching condition information.

For example, possible methods that the control unit 16 according to this concrete example 3 can use to detect the state of a program include to detect changes in the number of audio channels (stereo, mono, etc.) contained in the broadcast waves, to detect changes in the maximum value for the audio volume, and to detect changes in the status of the flag indicating the state of the program inserted into the broadcast waves.

This concrete example 3, an example associated with the third embodiment, may hold as switching information, and use as switching condition information, the information that this channel switching was not desirable to the user. Examples of situations that can be deemed as an undesirable channel switching include: the channel was switched to a new channel and the switching information was stored, but user instruction information was input to return the channel to the previous one; and, the channel was switched to another but the receiving condition on the new channel was worse than a predetermined threshold value.

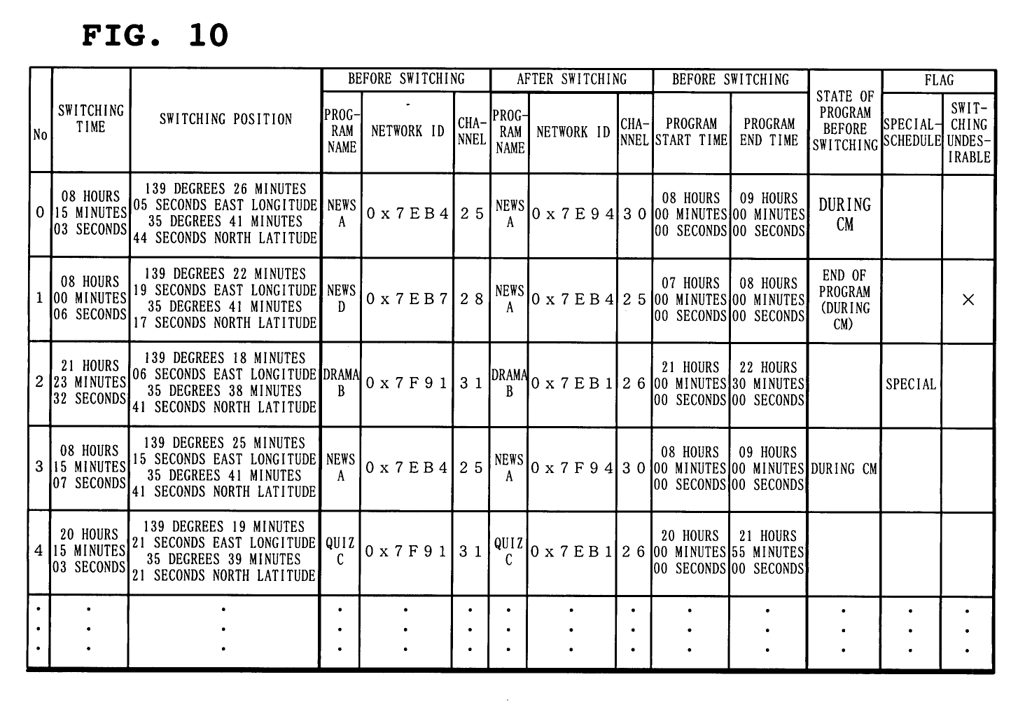

FIG. 10 shows an example of historical switching information generated by the historical switching information holding unit 20 according to this concrete example 3 by accumulating the switching information.

FIG. 10 is similar to FIG. 8, except that there are additional component items of the switching information to contain additional information, such as the start and end times of a program and flags.

Additional information according to this concrete example 3 consists of: the start and end times of a program before channel switching; the state of the program before channel switching; the special-schedule flag; and the switching desirable/undesirable flag.

The items of program start time and program end time indicates the program start time and program end time, stored by the historical switching information holding unit 20, for the program that is identical to the one currently being received. These items are used to determine whether or not these times differ from the program start time and program end time for the program currently being received. If it is determined that the times differ from the times for the current program, the information is excluded from the target of a search by the switching condition search unit 21.

In the item of the state of the program, the state of the program (e.g., during a CM) detected during channel switching is held.

If the user repeatedly switches the channel upon the occurrence of specific states of a program, then program state will also be used as a switching condition, in addition to position and time.

If the broadcast waves being received contain a flag indicating a program schedule different from usual, the information is held in the special-schedule flag item.

The switching information with this flag turned on does not relate to the usual program schedule, so it is excluded from the target of a search by the switching condition search unit 21.

The flag in the switching undesirable item is turned on when a channel switching is considered to have been undesirable to the user. Examples of situations that are deemed as undesirable channel switching include: the channel was switched to a new channel and the switching information was stored, but user instruction information was input to return the channel to the previous one; and, the channel was switched to another but the receiving condition on the new channel was worse than a predetermined threshold value and the channel was returned to the one before switching.

The switching information with this flag turned on is assumed to have been stored in association with a channel switching undesirable to the user, so it is excluded from the target of a search by the switching condition search unit 21.

For example, since the No. 1 and No. 2 switching information in FIG. 10 are not set as switching conditions, because the special-schedule flag or the switching undesirable flag is turned on.

Therefore, according to this concrete example 3, the user can avoid undesirable channel switching easily because the appropriateness of switching information to be set as a switching condition is determined based on the difference between the switching information in storage and the broadcast identification information contained in the broadcast waves that are being received by the broadcast receiver.

It is also possible to prevent the switching information saved from an undesirable channel switching event from being set as a switching condition.

### CONCRETE EXAMPLE 4

First, concrete example 1 will be explained. Concrete example 1 described above uses latitude, longitude, and altitude information acquired via GPS as position information to be acquired by the position information acquisition unit 14 or to be used as switching conditions. However, in the case of the broadcast receiver incorporated in a cell phone or PHS according to this concrete example 4, the position of the base station with which the broadcast receiver is communicating, the ID identifying this base station or other information in relation to this base station may be used as position information.

According this concrete example 4, broadcast, receivers without GPS functions can also acquire position information and use it as a switching condition. This position information preferably is detailed enough to identify the position of the broadcast receiver to some accuracy.

### CONCRETE EXAMPLE 5

Concrete example 5 will be described below. Concrete example 1 described above references the No. 0 and No. 3 items in FIG. 8 and the No. 0 item in FIG. 9, and indicates a range of times and a range of positions to switch the channel, instead of a specific time or position, as switching time and switching position information to be held as switching condition information. These ranges are expressed using the times and positions of two pieces of switching information that are highly correlated with each other. On the other hand, this concrete example 5 additionally holds the frequency of having been used for switching as switching condition information, and switches the channel at these high-frequency time and position in priority to the switching time and switching position held as switching condition information.

According to this concrete example 5, the channel is switched with priority at the conditions that were used for switching highly frequently, and thus the channel can be switched to ensure a better receiving condition, within the range of switching conditions indicated by multiple pieces of switching information. This way, channel switching can be performed in better consonance with user requirements, since the channel can be switched to ensure good receiving condition.

### CONCRETE EXAMPLE 6

Concrete example 6, an example of broadcast receiver according to the second embodiment shown in FIG. 5, will be described.

This concrete example 6 is similar to concrete example 1, up to the process of waiting for a switching condition to occur (step 407 in FIG. 4). In concrete example 1, the broadcast receiver 10 performs the channel switching process automatically (step 409) in response to the occurrence of a switching condition (step 408). This concrete example 6 differs from concrete example 1 in that alternative channels are presented to the user through the display unit 17 and the speaker 18 (step 410, FIG. 5) and that user instruction information is input (step 411) via, for example, the user's entry of an instruction to switch the channel, rather than performing the automatic channel switching process (step 409) in response to the occurrence of a switching condition (step 408).

For example, in the process of waiting for the occurrence of the No. 0 switching condition in FIG. 8, alternative channels are displayed on the display unit 17 to notify the user of the existence of alternative channels, when the broadcast receiver's receiving position is within the switching position range for the No. 0 switching condition and when the time of the No. 0 switching condition is reached.

Possible methods of presenting alternative channels include displaying an icon on the screen of the display unit 17, blinking an icon, blinking a switching button, issuing a voice announcement through the speaker 18, and notifying by an electronic or other sound.

Based on the presentation of alternative channels, the user operates the key input unit 13 to instruct the channel to be switched to an alternative channel, at the timing that the user desires.

Then, on the input of the user instruction information through the key input unit 13, the broadcast receiver switches the channel to the destination channel according to the input user instruction information.

According to this concrete example 6, the channel is switched under a condition that is in better consonance with the user's intention, because the user can shift the position and time of channel switching as necessary from the switching position and switching time indicated in the switching information.

It is also possible to combine the automatic and manual channel switching methods.

For example, the automatic channel switching method is adopted when the switching time in the switching condition can be specified.

When the switching time in the switching condition cannot be specified or when the channel could not be switched at the specified switching time, the manual channel switching method is adopted. The broadcast receiver then presents alternative channels to the user through the display unit 17 and the speaker 18, and waits for the input of user instruction information by the user.

In this case, since this concrete example 6 switches the channel automatically under a predetermined condition, it can meet the user's intention while saving the user from having to switch the channel manually.

### CONCRETE EXAMPLE 7

Concrete example 7 will be described below. In concrete example 6 above, the trigger for the historical switching information holding unit 20 to hold switching information is when user instruction information instructing “start search” to view the same program is input through the key input unit 13. In this concrete example 7, this trigger is when user instruction information instructing “start search” to view a different program is input through the key input unit 13.

In this concrete example, the historical switching information holding unit 20 holds switching information, using as the trigger “start search” on the detection of a deterioration in receiving condition and the consequent channel switching to another channel receivable in the area in which the broadcast receiver is located.

Furthermore, this concrete example may be a broadcast receiver having a means to specify the destination channel directly or a means to further narrow receivable channels by searching multiple channel candidates selected as destination channels in a predetermined order. In this case, a possible design is that the contents of these programs are confirmed by the user sequentially as the channel is switched according to the instruction of the user, and the information concerning the channel consequently selected by the user is held by the historical switching information holding unit 20 as switching information.

While the present invention has been described by taking up multiple preferred embodiments and concrete examples, it should be noted that the present invention is not limited to the preferred embodiments and concrete examples described above and that it can be implemented with a variety of modifications without departing from the spirit and scope of its technical principle.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A broadcast receiver with a radio broadcast reception function, comprising:
a switching condition setting unit that sets a switching condition for switching the channel being received, based on a status under which the channel was switched in the past, and
a channel switching unit that switches the channel on satisfaction of said switching condition.

2. A broadcast receiver with a radio broadcast reception function, comprising:
a switching information storage unit that accumulates statuses under which channel switching was performed as switching information, in response to a channel switching instruction from the user,
a switching condition setting unit that sets a switching condition for switching the channel, based on, among said switching information, said switching information that is close to the current status, and
a channel switching unit that switches the channel in accordance with said switching condition.

3. The broadcast receiver as set forth in claim 2, wherein
said switching information accumulated in said switching information storage unit includes at least one of the time and position at which the channel was switched, and the information that identifies the received contents before and after switching the channel.

4. The broadcast receiver as set forth in claim 2, wherein
information indicating said position, accumulated in said switching information storage unit, is information identifying the base station that is the source of said received content.

5. The broadcast receiver as set forth in claim 2, wherein
said switching information accumulated in said switching information storage unit includes information concerning the states of received radio waves before and after channel switching when channel switching took place, and
said switching condition set in said switching condition setting unit includes, among said switching information, information concerning the state of said received radio waves.

6. The broadcast receiver as set forth in claim 5, wherein
said channel switching unit switches the channel on satisfaction of, among said switching conditions, the switching condition set based on information concerning the state of said received radio waves, even though other switching conditions are yet to be satisfied.

7. The broadcast receiver as set forth in claim 2, wherein
said switching information accumulated in said switching information storage unit includes at least one of these information items: the channels before and after channel switching, network IDs and IDs identifying broadcast waves when channel switching took place.

8. The broadcast receiver as set forth in claim 2, wherein
said switching information accumulated in said switching information storage unit includes a channel switching instruction to return the channel after switching to the channel before switching, which was provided by the user within a predetermined length of time.

9. The broadcast receiver as set forth in claim 2, wherein
said switching information accumulated in said switching information storage unit is, among multiple channel switching instructions provided by the user within a predetermined length of time, the status of when the channel was switched in response to the last channel switching instruction provided.

10. A broadcast receiver with a radio broadcast reception function, comprising:
a switching information storage unit that accumulates statuses under which channel switching was performed as switching information, in response to a channel switching instruction from the user,
a switching condition setting unit that sets a switching condition for switching the channel, based on, among said switching information, said switching information that is close to the current status, and
a channel switching unit that switches the channel in accordance with said switching condition, wherein
said switching condition setting unit is a broadcast receiver described in any one of claims 1 to 9, comprising setting a switching condition by integrating, among said switching information, said switching information representing said statuses that are close to each other in some way.

11. A broadcast receiver with a radio broadcast reception function, comprising:
a switching condition setting unit that sets a switching condition for switching the channel being received, based on a status under which the channel was switched in the past, and
a channel switching unit that switches the channel on satisfaction of said switching condition, wherein
said channel switching unit is a broadcast receiver described in any one of claims 1 to 9, comprising switching the channel automatically when the switching condition is satisfied.

12. The broadcast receiver as set forth in claim 1, wherein
an output unit that outputs receivable channels on satisfaction of said switching condition is provided, and
said channel switching unit switches the channel in accordance with said switching condition and the channel switching instruction of the user.

13. The broadcast receiver as set forth in claim 12, wherein
said output unit outputs said receivable channels by video or sound.

14. The broadcast receiver as set forth in claim 2, wherein
said switching information accumulated in said switching information storage unit includes information that identifies the progress of the program contained in the broadcast waves, and
said switching condition setting unit does not set time information as said switching condition if the progress of the program that is being received and that is the subject of channel switching differs from the progress of said program in accumulation.

15. The broadcast receiver as set forth in claim 2, wherein
said switching information accumulated in said switching information storage unit includes the start time and end time of the program, and
said switching condition setting unit does not set time information as said switching condition if the start time or end time of the program that is being received and that is the subject of channel switching differs from the start time or end time of said program in accumulation.

16. A broadcast receiver with a radio broadcast reception function, comprising:
a switching condition setting unit that sets a switching condition for switching the channel being received, based on a status under which the channel was switched in the past, and
a channel switching unit that switches the channel on satisfaction of said switching condition, wherein
said channel switching unit is a broadcast receiver described in any one of claims 1-9, 12, 13, 14 or 15, comprising switching the channel on insertion of a commercial broadcast or on a change in audio state, based on the information that is contained in the broadcast waves and that identifies the content of the program.

17. A broadcast reception control program that forms part of a broadcast receiver with a radio broadcast reception function and that is executed on a computer, comprising:
making said broadcast receiver perform
a switching condition setting function to set a switching condition for switching the channel being received, based on a status of when the channel was switched in the past, and
a channel switching function to switch the channel on satisfaction of said switching condition.

18. A broadcast reception control program executed on a computer that forms a broadcast receiver with a radio broadcast reception function, comprising:
making said broadcast receiver perform
a switching information storage function to accumulate as switching information a status of when channel switching was performed, in response to a channel switching instruction from the user,
a switching condition setting function to set a switching condition for switching the channel, based on, among said switching information, said switching information that is close to the current status, and
a channel switching function to switch the channel in accordance with said switching condition.

19. The broadcast reception control program as set forth in claim 18, wherein
said switching information accumulated by said switching information storage function includes at least one of the time and position at which the channel was switched, and the information that identifies the received contents before and after switching the channel.

20. The broadcast reception control program as set forth in claim 18, wherein
information indicating said position, accumulated by said switching information storage function, is information identifying the base station that is the source of said received content.

21. The broadcast reception control program as set forth in claim 18, wherein
said switching information accumulated by said switching information storage function includes information concerning the states of received radio waves before and after channel switching when channel switching took place; and
said switching condition set in said switching condition setting unit includes, among said switching information, information concerning the state of said received radio waves.

22. The broadcast reception control program as set forth in claim 21, wherein
said channel switching function switches the channel on satisfaction of, among said switching conditions, the switching condition set based on information concerning the state of said received radio waves, even though other switching conditions are yet to be satisfied.

23. The broadcast reception control program as set forth in claim 18, wherein
said switching information accumulated by said switching information storage function includes at least one of these information items: the channels before and after channel switching, network IDs and IDs identifying broadcast waves when channel switching took place.

24. The broadcast reception control program as set forth in claim 18, wherein
said switching information accumulated by said switching information storage function includes a channel switching instruction to return the channel after switching to the channel before switching, which was provided by the user within a pre-determined length of time.

25. The broadcast reception control program as set forth in claim 18, wherein
said switching information accumulated by said switching information storage function is, among multiple channel switching instructions provided by the user within a predetermined length of time, the status of when the channel was switched in response to the last channel switching instruction provided.

26. The broadcast reception control program as set forth in claim 17, wherein
said switching condition setting function sets a switching condition by integrating, among said switching information, said switching information representing said statuses that are close to each other in some way.

27. The broadcast reception control program as set forth in claim 17, wherein
said channel switching function switches the channel automatically on satisfaction of said switching condition.

28. The broadcast reception control program as set forth in claim 17, wherein
said broadcast receiver is made to perform
an output function to output receivable channels on satisfaction of said switching condition, and
said channel switching function switches the channel in accordance with said switching condition and the channel switching instruction of the user.

29. The broadcast reception control program as set forth in claim 28, wherein
said output function outputs said receivable channels by video or sound.

30. The broadcast reception control program as set forth in claim 18, wherein
said switching information accumulated by said switching information storage function includes information that identifies the progress of the program contained in the broadcast waves, and
said switching condition setting function does not set time information as said switching condition if the progress of the program that is being received and that is the subject of channel switching differs from the progress of said program in accumulation.

31. The broadcast reception control program as set forth in claim 18, wherein
said switching information accumulated by said switching information storage function includes the start time and end time of the program, and
said switching condition setting function does not set time information as said switching condition if the start time or end time of the program that is being received and that is the subject of channel switching differs from the start time or end time of said program in accumulation.

32. The broadcast reception control program as set forth in claim 17, wherein
said channel switching function switches the channel on insertion of a commercial broadcast or on a change in audio state, based on the information that is contained in the broadcast waves and that identifies the content of the program.

33. A reception channel switching method for a broadcast receiver with a radio broadcast reception function, comprising:
a switching condition setting step to set a switching condition for switching the channel being received, based on a status of when the channel was switched in the past, and
a channel switching step to switch the channel on satisfaction of said switching condition.

34. A reception channel switching method for a broadcast receiver with a radio broadcast reception function, comprising:
a switching information storage step to accumulate statuses under which channel switching was performed as switching information, in response to a channel switching instruction from the user,
a switching condition setting step to set a switching condition for switching the channel, based on, among said switching information, said switching information that is close to the current status, and
a channel switching step to switch the channel in accordance with said switching condition.

35. The reception channel switching method as set forth in claim 34, wherein
said switching information accumulated in said switching information storage step includes at least one of the time and position at which the channel was switched, and the information that identifies the received contents before and after switching the channel.

36. The reception channel switching method as set forth in claim 34, wherein
information indicating said position, accumulated by said switching information storage step, is information identifying the base station that is the source of said received content.

37. The reception channel switching method as set forth in claim 34, wherein
said switching information accumulated in said switching information storage step includes information concerning the states of received radio waves before and after channel switching when channel switching took place, and
said switching condition set in said switching condition setting step includes, among said switching information, information concerning the state of said received radio waves.

38. The reception channel switching method as set forth in claim 37, wherein
said channel switching step switches the channel on satisfaction of, among said switching conditions, the switching condition set based on information concerning the state of said received radio waves, even though other switching conditions are yet to be satisfied.

39. The reception channel switching method as set forth in claim 34, wherein
said switching information accumulated in said switching information storage step includes at least one of these information items: the channels before and after channel switching, network IDs and IDs identifying broadcast waves when channel switching took place.

40. The reception channel switching method as set forth in claim 34, wherein
said switching information accumulated in said switching information storage step includes a channel switching instruction to return the channel after switching to the channel before switching, which was provided by the user within a pre-determined length of time.

41. The reception channel switching method as set forth in claim 34, wherein
said switching information accumulated in said switching information storage step is, among multiple channel switching instructions provided by the user within a predetermined length of time, the status of when the channel was switched in response to the last channel switching instruction provided.

42. The reception channel switching method as set forth in claim 33, wherein
said switching condition setting step sets a switching condition by integrating, among said switching information, said switching information representing said statuses that are close to each other in some way.

43. The reception channel switching method as set forth in claim 33, wherein
said channel switching step switches the channel automatically on satisfaction of said switching condition.

44. The reception channel switching method as set forth in claim 33, wherein
an output step to output receivable channels on satisfaction of said switching condition is provided, and
said channel switching step switches the channel in accordance with said switching condition and the channel switching instruction of the user.

45. The reception channel switching method as set forth in claim 44, wherein
said output step outputs said receivable channels by video or sound.

46. The reception channel switching method as set forth in claim 34, wherein
said switching information accumulated by said switching information storage step includes information that identifies the progress of the program contained in the broadcast waves, and
said switching condition setting step does not set time information as said switching condition if the progress of the program that is being received and that is the subject of channel switching differs from the progress of said program in accumulation.

47. The reception channel switching method as set forth in claim 34, wherein
said switching information accumulated by said switching information storage step includes the start time and end time of the program, and
said switching condition setting step does not set time information as said switching condition if the start time or end time of the program that is being received and that is the subject of channel switching differs from the start time or end time of said program in accumulation.

48. The reception channel switching method as set forth in claim 33, wherein
said channel switching step switches the channel on insertion of a commercial broadcast or on a change in audio state, based on the information that is contained in the broadcast waves and that identifies the content of the program.
